(19) United States
(12) Patent Application Publication
(10) Pub. No.: US 2003/0198935 A1
(43) Pub. Date: Oct. 23, 2003

(54) Real-time display method for interactive teaching

(76) Inventors: Say-Yee Wen, Taipei (TW); Shih-Li Wen, Taipei (TW)

Correspondence Address: BIRCH STEWART KOLASCH & BIRCH, PO BOX 747, FALLS CHURCH, VA, 22040-0747, US

(21) Appl. No.: 10/124,480

(22) Filed: Apr. 18, 2002

(51) Int. Cl. G09B 3/00

(52) U.S. Cl. 434/350

(57) ABSTRACT

A real-time display method for the applications in an interactive teaching system is disclosed. This method provides teachers a way to transfer multimedia data from a host to clients of students and to simultaneously display the data through a network connection. It is of great benefits for teachers to mark important sections or to provide immediate calculations, tests, and solutions.

### BACKGROUND OF THE INVENTION

1. Field of Invention

The invention relates to a real-time display method for interactive teaching. In particular, it can be applied to an interactive teaching system consisting of electronic devices such as PDA (Personal Digital Assistant).

2. Related Art

The conventional teaching method uses data printed in books or paper as the teaching and learning materials. For students, however, these heavy paper materials form burdens to their bodies. In addition to the physical pressure brought by the materials, these materials have only fixed contents that may not be enough to cover all that a student needs to learn or sufficiently clear in presenting the relevant materials. Therefore, teachers play an important role in explaining the information contained in the materials. A usual way used by the teachers is to supply the students with more papers or notes. This then adds to students more burdens.

Since E-books advocated by people have the advantages of essential no weight and providing multimedia data, using PDA to provide interactive teaching makes both teachers and students much relieved in physical burdens. The compact and light PDA can replace innumerous books, references, notes, tests, and commentary data. Therefore, they are truly a major trend in future teaching and learning.

### SUMMARY OF THE INVENTION

To solve the above problems, the invention provides a real-time display method for interactive teaching so that the teacher can write or enter multimedia data from a host. Such supplementary data are simultaneously displayed on client machines of students. Through the linkage between the host and the clients and the simultaneous display, the teacher can mark important places in the learning materials or provide real-time calculations, notes, questions and answers.

In accordance with the disclosed real-time display method for interactive teaching, teachers can display information on client machines of students from a host through a network and solve problems or questions raised by students in real time. The method includes the steps of:

logging a client onto a LAN (Local Area Network);

sending a conversion request command to the client from a host of the LAN;

converting the client into a real-time display mode;

the host's receiving teaching information; and

simultaneously displaying the teaching information on the client.

When a student raises a question, the teacher can answer using the real-time display function. He or she may even forward the question and answer to all other students.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the connections between the host and the clients according to a first embodiment of the invention;

FIG. 2 is a schematic view of the connections between the host and the clients according to a second embodiment of the invention;

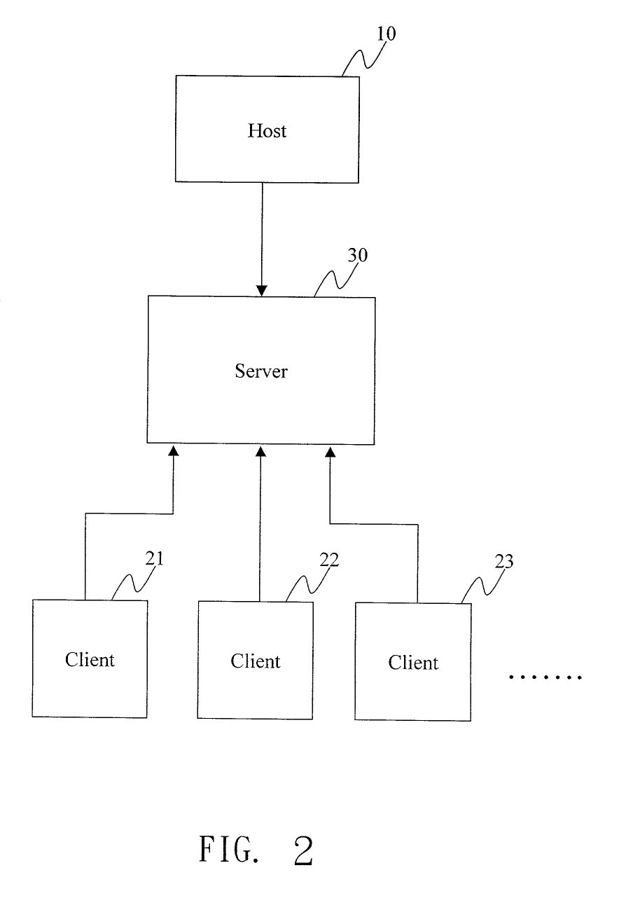

FIG. 3 is a schematic view of different ways to provide teaching information;

FIG. 4 shows the steps of the disclosed method; and

FIG. 5 shows the steps in the real-time display of raising questions and providing answers.

### DETAILED DESCRIPTION OF THE INVENTION

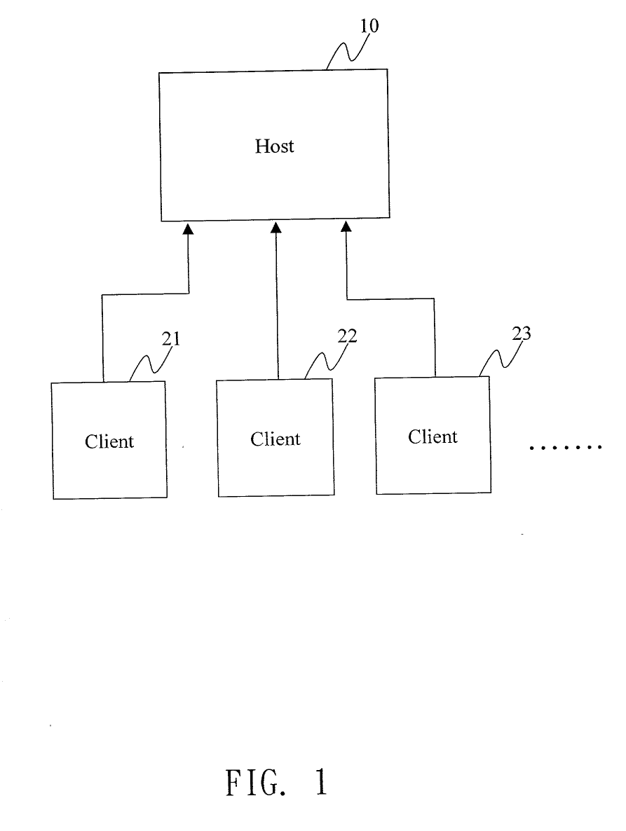

With reference to FIG. 1, electronic devices such as portable computers, mobile communication device, and PDA (Personal Digital Assistant) may constitute a teaching system. The electronic device used by a teacher (hereinafter referred as the host 10) and electronic devices used by students (hereinafter referred as the clients 21, 22, 23) are connected to form an internal LAN (Local Area Network). In other words, the host 10 provides the function of a server that administrates the internal LAN for the clients 21, 22, 23 to log on. It assigns and manages the privileges of the clients. The connection can be either wired or wireless (e.g. the Bluetooth technology). Of course, one may utilize a server 30 to be a network host to minimize the burden of the host 10.

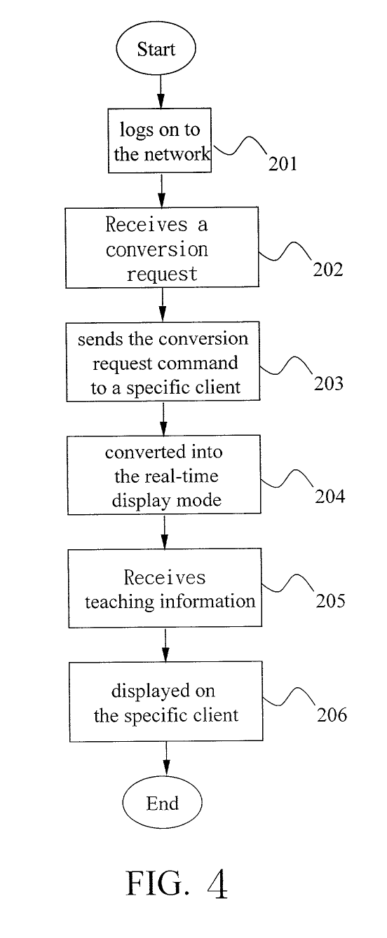

As shown in FIG. 4, a client 21 (or 22, 23) logs on to the network first (step 201). When the teacher decides to use the real-time display teaching mode, the teacher sends a conversion request command to the host 20(step 202). Then the host 20 sends the conversion request command to a specific client 21 (or 22, 23) (step 203). (The so-called specific client will be defined later.) The specific client 21 (or 22, 23) is then converted into the real-time display mode (step 204). The teacher then enters teaching information to the host 10 (step 205). The teaching information is then displayed on the specific client 21 (or 22, 23) at the same time (step 206).

The specific client 21 (or 22, 23) is one on which the teacher chooses to display certain additional information according to the student's needs. For example, the class may be divided into groups for discussion. The data of each topic are then transferred to the persons in the assigned group only. For students who make slower progress and need special attention, the teacher can send more detailed and basic or simpler contents to them without displaying the same things on other clients. For students who can accept more advanced or challenging topics, the teacher can also send such information to those students only without giving others too much work to do.

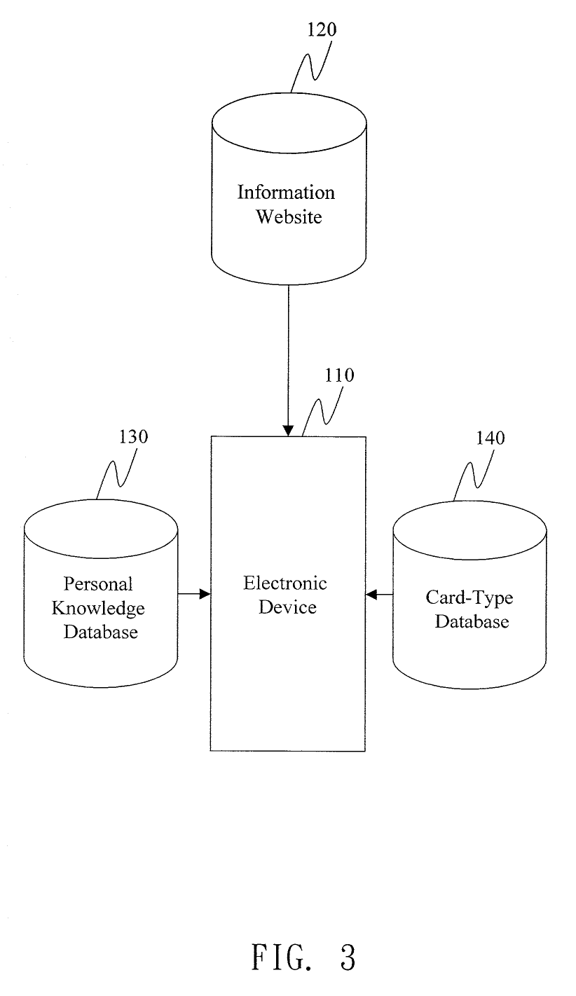

With the help of PDA, the teaching contents can be varied and more interesting. They may include such multimedia information as audios, texts, videos, pictures and animations. The sources of teaching materials, as shown in FIG. 3, may be data provided on an information website 120, a personal knowledge database 130, and a card-type database 140. Of course, the teacher can use devices such as a hand-written panel and a touch-control pen to enter teaching materials. The teaching contents may be mathematical equations, emphasis points, class notes, quizzes, supplementary materials, etc. Taking mathematical equations as an example, the students do not need to copy them from the blackboard down to their notebooks while at the same time trying to comprehend the techniques. Using the disclosed real-time display function, the students only need to concentrate on the skills from their own client machines 21 (or 22, 23). Furthermore, the teacher can mark emphasis points on the teaching materials so that the students know what have been emphasized by the teacher. Thus, the job of taking notes becomes much simpler.

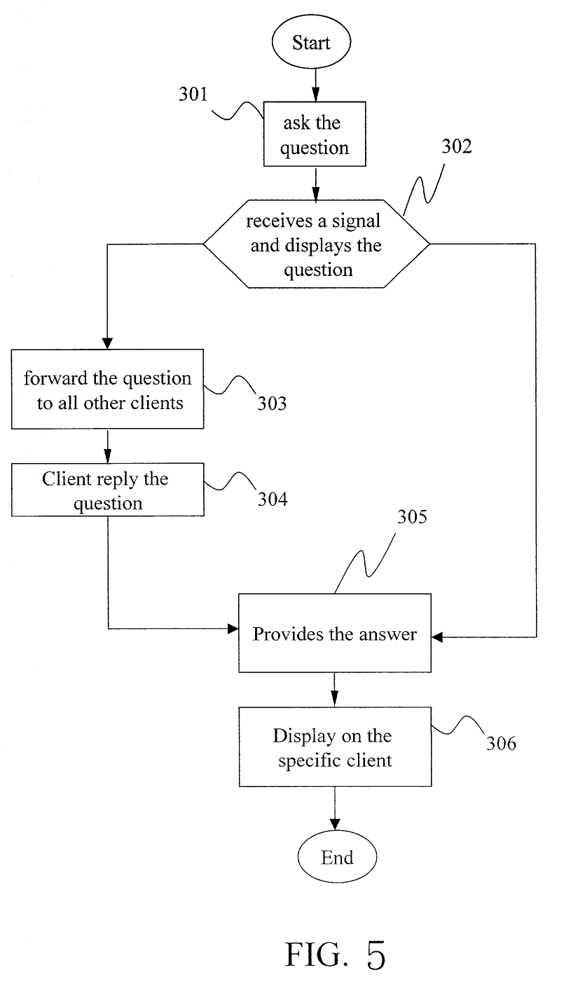

If any student has a question during the teaching procedure, he or she can utilize the real-time display function to achieve the goals of interactive learning, real-time replay and sharing. With reference to FIG. 5, when some student has a question, he or she can use the real-time display function to ask the question (step 301). The host 10 of the teacher immediately receives a signal from the student and displays the question (step 302). Of course, there are different ways of asking questions: oral or text. For each question, the teacher can choose to answer directly to the specific student (step 305) or, to avoid the same question from other students, to forward the question to all other clients (step 303) for them to ask similar questions or answer this question. If one client 21 (or several of them) answers this question (step 304), the answer is then provided to the student (step 305). Therefore, the answer can be provided by either the teacher or any student. Not only can this answer be displayed on the electronic device of the answer provider but also simultaneously on the student who asks the question or even on other students if necessary (step 306). This method can also be applied for the teacher to ask questions in the class. In this case, the sources and transmissions of answers are exactly the same as the previous one.

Effects of the Invention

The invention is a real-time display method for interactive teaching. Through privilege management, the teacher can write or enter multimedia data from his or her electronic device (i.e. the host) and have them simultaneously displayed on the electronic devices of the students (i.e. the clients). With such real-time display between the host and the clients, the teacher can make marks in the teaching materials, perform real-time calculations, or write notes. Through the privilege control, the students can raise questions or provide answers which will be simultaneously displayed on the host. The teacher can directly reply to the student who asks the question. He or she may also choose to forward the question and/or answer to all student clients to avoid or stimulate other similar questions. If any student has a brilliant idea toward the learning materials, the screen of the client may be simultaneously displayed on the host and other clients.

What is claimed is:

1. A real-time display method for interactive teaching applied to a first electronic device for teaching and a plurality of second electronic devices for learning, which method comprises the steps of:
receiving a conversion request command by the first electronic device;
sending the conversion request command through the first electronic device to a specific second electronic device;
converting the specific second electronic device into a real-time display mode;
the first electronic device's receiving teaching information; and
simultaneously displaying the teaching information on the specific second electronic device.

2. The method of claim 1, wherein the teaching information is provided from a place selected from the group consisting of an information website, a personal knowledge database, and a card-type database.

3. The method of claim 1, wherein the teaching information is multimedia information comprising audios, texts, videos, pictures, and animations.

4. The method of claim 1, wherein the step of simultaneously displaying the teaching information on the specific second electronic device is followed by the step of sending a question signal from one of the second electronic devices to the first electronic device.

5. The method of claim 4, wherein the step of sending a question signal from one of the second electronic devices to the first electronic device is followed by the step of replying an answer from the first electronic device to the second electronic device.

6. The method of claim 1, wherein the first electronic device and the second electronic devices are selected from the group consisting of portable computers, mobile communication devices, and PDAs (Personal Digital Assistants).

7. The method of claim 1, wherein the connection between the first electronic device and the second electronic devices is selected from the group consisting of wired and wireless communications.

8. The method of claim 1, wherein the first electronic device functions as a server for connections from the second electronic devices to form an internal network.

9. A real-time display method applied to an interactive teaching system consisting of a first electronic device for teaching and a plurality of second electronic devices for learning, which method comprises the steps of:
receiving a conversion request command by the first electronic device;
sending the conversion request command through the first electronic device to a specific second electronic device;
converting the specific second electronic device into a real-time display mode;
the first electronic device's receiving teaching information;
simultaneously displaying the teaching information on the specific second electronic device;
sending a question signal from one of the second electronic devices to the first electronic device; and
replying an answer from the first electronic device to the second electronic device.

10. The method of claim 9, wherein the teaching information is provided from a place selected from the group consisting of an information website, a personal knowledge database, and a card-type database.

11. The method of claim 9, wherein the teaching information is multimedia information comprising audios, texts, videos, pictures, and animations.

12. The method of claim 9, wherein the first electronic device functions as a server for connections from the second electronic devices to form an internal network.

13. The method of claim 9, wherein the step of replying an answer from the first electronic device to the second electronic device is followed by the step of simultaneously sending the answer to the rest of the second electronic devices.

14. The method of claim 9, wherein the first electronic device and the second electronic devices are selected from the group consisting of portable computers, mobile communication devices, and PDAs (Personal Digital Assistants).

15. The method of claim 9, wherein the connection between the first electronic device and the second electronic devices is selected from the group consisting of wired and wireless communications.

16. A real-time display method applied to an interactive teaching system consisting of a server, a host PDA (Personal Digital Assistant) at a control end and a plurality of client PDA at receiving ends where the host forms a LAN (Local Area Network) with the clients through the server and controls the clients, which method comprises the steps of:
a client's logging onto the LAN;
sending a conversion request command from the host to the client through the LAN;
converting the client into a real-time display mode;
the host's receiving teaching information; and
simultaneously displaying the teaching information on the client.

17. The method of claim 16, wherein the step of simultaneously displaying the teaching information on the client is followed by the steps of:
sending a question signal from one of the clients to the host; and
replying an answer from the host to the client with the question.

18. The method of claim 17, wherein the answer contains multimedia information comprising audios, texts, videos, pictures, and animations.

19. The method of claim 18, wherein the answer is provided to a group of clients.

20. The method of claim 18, wherein the answer is transmitted from one of the clients to the rest of the clients and the host.
